(19) United States
(12) Patent Application Publication
(10) Pub. No.: US 2024/0343914 A1
(43) Pub. Date: Oct. 17, 2024

(54) Curable Composition, Cured Composition, and Composite Article, and Method of Making the Same

(71) Applicant: 3M INNOVATIVE PROPERTIES COMPANY, Saint Paul, MN (US)

(72) Inventors: Jitendra S. Rathore, Woodbury, MN (US); Kara A. Meyers, Oakdale, MN (US); Nicholas T. Gabriel, Grand Rapids, MN (US); Kayla C. Picha, Maplewood, MN (US); Howard M. Kaplan, Mahtomedi, MN (US); Shawn C. Dodds, St. Paul, MN (US); Lyudmila A. Pekurovsky, Bloomington, MN (US)

(21) Appl. No.: 18/577,803

(22) PCT Filed: Jul. 25, 2022
(86) PCT No.: PCT/IB2022/056853

§ 371 Date: Jan. 9, 2024

Related U.S. Application Data
(60) Provisional application No. 63/232,358, filed on Aug. 12, 2021.

(51) Int. Cl. C09D 5/00; C08J 7/04; C08J 7/043; C09D 183/04

(52) U.S. Cl. CPC C09D 5/002; C08J 7/042; C08J 7/043; C09D 183/04; C08J 2375/04; C08J 2379/08; C08J 2483/04

(57) ABSTRACT

A curable composition comprises a siloxane compound and a tetraalkyl orthotitanate. The siloxane compound comprises m divalent units represented by the formula —SiH(R¹)O—, n divalent units represented by the formula —Si(R¹)(OR²)O—, and p divalent units represented by the formula —Si(R¹)₂O—, wherein each R¹ independently represents an alkyl group having from 1 to four carbon atoms, each R² independently represents H or an alkyl group having from 1 to four carbon atoms, m and n are integers greater than or equal to 1, and p is an integer greater than or equal to 0. An at least partially cured curable composition and composite articles including the same are also disclosed.

### BACKGROUND

Silicone encapsulants are used to protect various components in electronic devices from environmental damage. In many cases, the silicone encapsulant must adhere well to a flexible polymer film made of polyimide or thermoplastic polyurethane.

### SUMMARY

Many silicone encapsulants do not bond strongly to flexible polymer films such as polyimide and thermoplastic polyurethane. The present disclosure solves this problem by providing materials and methods that can be used to provide a tie layer to improve bonding of the silicone encapsulant to the polymer film.

In a first aspect, the present disclosure provides a curable composition comprising:
(i) a siloxane compound comprising:
   m divalent units represented by the formula

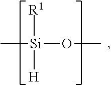

n divalent units represented by the formula

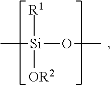

and
p divalent units represented by the formula

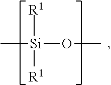

wherein each R¹ independently represents an alkyl group having from 1 to four carbon atoms, each R² independently represents H or an alkyl group having from 1 to four carbon atoms, m and n are integers greater than or equal to 1, and p is an integer greater than or equal to 0. and
(ii) a tetraalkyl orthotitanate.

In another aspect, the present disclosure provides an at least partially cured curable composition according to the present disclosure.

In yet another aspect, the present disclosure provides a composite article comprising:
a substrate having a major surface; and
a tie layer disposed on the major surface of the substrate, the tie layer comprising an at least partially cured curable composition according to the present disclosure.

In yet another aspect, the present disclosure provides a method of making a composite article, the method comprising:
providing a substrate having a tie layer comprising an at least partially cured curable composition according to the present disclosure disposed on a surface thereof;
contacting a curable silicon-containing resin with the tie layer; and
at least partially curing the curable silicon-containing resin.

As used herein:
the term “siloxane compound” refers to a compound having a molecular structure based on a chain of alternate silicon and oxygen atoms having organic groups attached to the silicon atoms; and
the term “tie layer” refers to a layer that may improve adhesion between dissimilar adherends if disposed therebetween. A tie layer may not be disposed between two adherends in every case (for example, it may be disposed on a single substrate as with a primer).

Features and advantages of the present disclosure will be further understood upon consideration of the detailed description as well as the appended claims.

### BRIEF DESCRIPTION OF THE DRAWINGS

FIG. 1 is a schematic side view of an exemplary composite article 100 according to the present disclosure.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Curable compositions according to the present disclosure comprise a siloxane compound and a tetraalkyl orthotitanate.

The siloxane compound comprises:
m divalent units represented by the formula

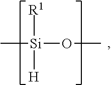

n divalent units represented by the formula

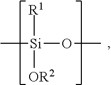

and
p divalent units represented by the formula

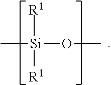

Each R¹ independently represents an alkyl group having from 1 to four carbon atoms. Examples include methyl, ethyl, propyl, and butyl.

Each R² independently represents H or an alkyl group having from 1 to four carbon atoms. Examples include H, methyl, ethyl, propyl, and butyl.

In some embodiments, each R¹ and R² is methyl. In some embodiments, each R¹ is methyl and each R² is ethyl.

Both m and n independently represent integers greater than or equal to 1 (e.g., ≥1, ≥2, ≥3, ≥4, ≥5, ≥10, ≥15, ≥20, or ≥50), and p represents an integer greater than or equal to 0 (e.g., ≥0, ≥1, ≥2, ≥3, ≥4, ≥5, ≥10, ≥15, ≥20, or ≥50). In some embodiments, the relative ratio m:n:p is 1-5:1-20:0-50. In some embodiments, the ratio m:n (i.e., m/n) is in the range of 1:20 to 20:1, inclusive, preferably 1:25 to 1.35, inclusive.

In some embodiments, the siloxane compound is linear. In these embodiments, the siloxane compound may comprise a linear polymer. In some embodiments, the linear polymer has a number average molecular weight (Mₙ) of 400 to 10000 grams/mole, preferably 500 to 2000 grams/mole, although higher and lower molecular weights may also be used.

Siloxane compounds of the foregoing types can be made, for example, by reaction of a portion of hydride groups on a silicone having —OSiH(R¹)O— and optionally —OSi(R¹)₂O— divalent groups with an alkanol, which results in replacement of hydride with the corresponding alkoxide, as generally illustrated in Scheme I, below:

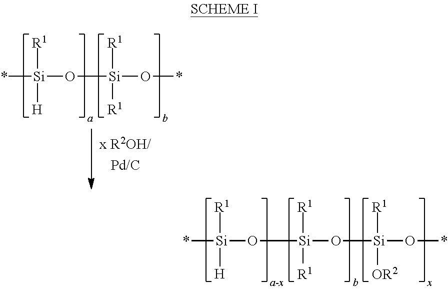

wherein R¹ and R² are as previously defined, a and x represent integers greater than or equal to one, and b represent an integer greater than or equal to zero. * indicates additional unspecified structure composed of a combination of Si, C, H, and/or O atoms (e.g., trimethylsiloxy and methyl, respectively), or the two *'s taken together may form a covalent bond resulting in a cyclic structure as discussed hereinbelow.

Trimethylsiloxy-terminated methylhydrosiloxane-dimethylsiloxane copolymers, suitable for use in the above reaction can be made by conventional methods and/or obtained from commercial suppliers such as, for example: Gelest Inc., Morrisville, Pennsylvania (e.g., product codes: HMS-013, HMS-031, HMS-053, HMS-064, HMS-071, HMS-082, HMS-151, HMS-301*, and HMS-501); SiSiB Silanes and Silicones, Nanjing, China (e.g., under the trade designations SISIB HF2050 in grades 100H75, 15H75, 55H55, 22H55, 60H36, 15H36, 15H100, 60H120, 15H43, 115H41, 21H20, 70H18, and 20H11); or Dow Corning, Midland, Michigan (e.g., under the trade designation SYL-OFF 7678).

In some embodiments, the siloxane compound is cyclic. Exemplary such siloxane compounds can be represented by the formula

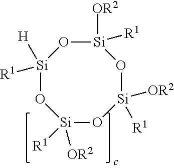

wherein R¹ and R² are as previously defined and c is 0, 1, or 2.

Combinations of cyclic siloxane compounds and combinations of linear siloxane compounds may be used. Combinations of cyclic and linear siloxane compounds may also be used.

The tetraalkyl orthotitanate is a compound represented by the formula

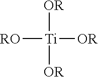

wherein each R independently represents an alkyl group. In some preferred embodiments, each R independently has from 1 to 12 carbon atoms, more preferably from 1 to 8 carbon atoms. Examples of R include methyl, ethyl, n-propyl, isopropyl, n-butyl, isobutyl, n-pentyl, isopentyl, n-hexyl, isohexyl, n-heptyl, n-octyl, isooctyl, 2-ethyl-1-hexyl, n-decyl, and n-dodecyl. Typically, all four R groups are the same, although this is not a requirement.

Tetraalkyl orthotitanates can be made, for example, by reaction of titanium tetrachloride with an alkanol, or they may be obtained from commercial suppliers such as Sigma-Aldrich Chemical Co., Saint Louis, Missouri, or DuPont, Wilmington, Delaware.

The tetraalkyl orthotitanate catalyzes crosslinking of the siloxane compound through hydrosilylation of alkoxy groups and generation of the corresponding alcohol. The amount of tetraalkyl orthotitanate relative to siloxane compound may be any amount, for example, depending on the relative molecular and/or equivalent weights. In many embodiments, the tetraalkyl orthotitanate is present in an amount of 5 percent or less based on the combined total weight of the tetraalkyl orthotitanate and the siloxane compound.

In some embodiments, the curable composition further comprises at least one trialkoxysilane, preferably having 3 to 18 carbon atoms, more preferably 3 to 12 carbon atoms, and more preferably 3 to 6 carbon atoms. Exemplary trialkoxysilanes include trimethoxysilane, triethoxysilane, tripropoxysilane, and tributoxysilane.

Typically, the curable composition is formulated to be essentially free of water; that is, free of more than unintended adventitious amounts of water (e.g., less than 0.01 percent, less than 0.001, or even less than 0.0001 percent by weight of water).

The curable composition can be at least partially cured (e.g., cured to at least a non-flowable state or fully cured) by application of thermal energy; for example, by heating in an oven at about 80° C. or by using a heat lamp or heat gun.

The curable composition can be applied to a substrate and at least partially cured (preferably fully cured) to provide a tie layer when contacted with another material such as, for example a silicone encapsulant resin.

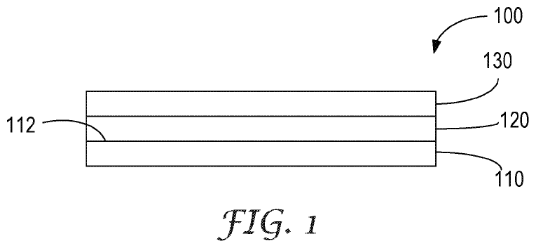

Accordingly, FIG. 1 depicts a composite article 100 comprising a substrate 110 having a major surface 112 and a tie layer 120 disposed on the major surface 112. The tie layer comprises an at least partially cured curable composition according to the present disclosure. Optional silicone elastomer 130 layer is disposed on at least a portion of tie layer 120.

Exemplary substrates include flexible films (and other flexible substrates) comprising polymers such as, for example, polyimides, thermoplastic polyurethanes, polyesters, polyolefins (e.g., polyethylene and polypropylene), polyamides, and acrylics; and especially those used in electronics applications (e.g., polyimide and thermoplastic polyurethane). The substrate may also be rigid (e.g., an epoxy circuit board) or a combination of flexible and rigid. The substrate may comprise an inorganic material such as glass or ceramic, or an organic material such as an organic polymer or wood.

The curable composition may be applied to the substrate by any suitable methods including, for example, spraying, roll coating, ink jet printing, screen printing, dip coating, knife coating, curtain coating, brush coating, bar coating, slot coating, and wire-wound rod coating. Any desired thickness may be used. In many embodiments, the curable composition is applied at a dried and/or cured thickness of 0.5 to 10 microns.

To facilitate coating/printing the curable composition may contain any amount of organic solvent (e.g., ethyl acetate and/or heptane).

In some embodiments, a curable silicon-containing resin can be disposed on the tie layer and cured. Any curable silicone-containing resin may be used. Examples include RTV and moisture-curable silicone resins. In some preferred embodiments, the curable silicon-containing resin is curable by a hydrosilylation reaction and contains an effective amount of hydrosilylation catalyst. Exemplary hydrosilylation-curable silicone resins include mixtures of hydride-containing silicones with vinyl-containing silicone resins in combination with a hydrosilylation catalyst.

Hydrosilylation, also called catalytic hydrosilylation, describes the addition of Si—H bonds across unsaturated bonds. The hydrosilylation reaction is typically catalyzed by a platinum catalyst, and generally heat is applied to effect the reaction. In this reaction, the Si—H adds across the double bond to form new C—H and Si—C bonds. This process in described, for example, in PCT Publication No. WO 2000/068336 (Ko et al.), and PCT Publication Nos. WO 2004/111151 (Nakamura) and WO 2006/003853 (Nakamura).

Useful hydrosilylation catalysts may include thermal catalysts (which may be activated at or above room temperature) and/or photocatalysts. Of these, photocatalysts may be preferred due to prolonged storage stability and ease of handling. Exemplary thermal catalysts include platinum complexes such as H₂PtCl₆ (Speier's catalyst); organometallic platinum complexes such as, for example, a coordination complex of platinum and a divinyldisiloxane (Karstedt's catalyst); and chloridotris-(triphenylphosphine)rhodium(I) (Wilkinson's catalyst),

Useful platinum photocatalysts are disclosed, for example, in U.S. Pat. No. 7,192,795 (Boardman et al.) and references cited therein. Certain preferred platinum photocatalysts are selected from the group consisting of Pt(II) β-diketonate complexes (such as those disclosed in U.S. Pat. No. 5,145,886 (Oxman et al.)), (η5-cyclopentadienyl)tri(o-aliphatic)platinum complexes (such as those disclosed in U.S. Pat. No. 4,916,169 (Boardman et al.) and U.S. Pat. No. 4,510,094 (Drahnak)), and C7-20-aromatic substituted (η5-cyclopentadienyl)tri(σ-aliphatic)platinum complexes (such as those disclosed in U.S. Pat. No. 6,150,546 (Butts)). Hydrosilylation photocatalysts are activated by exposure to actinic radiation, typically ultraviolet light, for example, according to known methods.

The amount of hydrosilylation catalyst may be any effective amount. In some embodiments, the amount of hydrosilylation catalyst is in an amount of from about 0.5 to about 30 parts by weight of platinum per one million parts by weight of the total composition in which it is present, although greater and lesser amounts may also be used.

Hydrosilylation-curable silicone resins are commercially available and/or can be made according to known methods, for example, as described in U.S. Pat. No. 10,793,681 (Sweier et al.) and U.S. Pat. Appln. Publ. No. 2021/0032469 (Hayashi et al.). Commercial suppliers of hydrosilylation-curable silicone resins include: Shin-Etsu Chemical Co., Ltd., Tokyo, Japan; Dow Silicones, Midland, Michigan; Momentive Performance Materials, Waterford, New York; Wacker Chemicals, Adrian, Missouri, and Gelest, Inc, Morrisville, Pennsylvania.

Objects and advantages of this disclosure are further illustrated by the following non-limiting examples, but the particular materials and amounts thereof recited in these examples, as well as other conditions and details, should not be construed to unduly limit this disclosure.

### Examples

Unless otherwise noted, all pains, percentages, ratios, etc. in the examples are by weight. Unless otherwise specified, all reagents used in the examples were obtained, or are available, from general chemical suppliers such as, for example, Sigma-Aldrich, Inc., Saint Louis, Missouri, or may be synthesized by conventional methods.

Materials used in the Examples are reported in Table 1, below.

TABLE 1

| ABBREVI- | |
|---|---|
| ATION | DESCRIPTION |
| DMS-V46 | DMS-V46 vinyl-terminated PDMS, viscosity = |
| | 60,000 cSt (0.06 m²/s), obtained from |
| | Gelest Inc, Morrisville, Pennsylvania |
| DMS-S45 | DMS-S45 silanol-terminated polydimethylsiloxane, |
| | viscosity = 50,000 cSt (0.05 m²/s), obtained |
| | from Gelest Inc. |
| SYL-OFF 7678 | SYL-OFF 7678 silane crosslinker, 100 weight |
| | percent solids, obtained from Dow Corning Corp., |
| | Midland, Michigan |
| SYL-OFF 7048 | SYL-OFF 7048 silane crosslinker, 100 weight |
| | percent solids, obtained from Dow Corning Corp. |
| Pd/C | 5.0 wt. % palladium loading on activated charcoal was |
| | obtained from Sigma-Aldrich, Inc. |
| Titanium | titanium (IV) 2-ethylhexoxide, a Ti(IV) complex |
| complex-1 | alternatively known as tetraoctyl titanate or |
| | tetrakis(2-ethylhexyl) orthotitanate, was obtained |
| | from Gelest, Inc. |
| Titanium | titanium(IV) butoxide, alternatively known as tetrabutyl |
| complex-2 | orthotitanate was purchased from Sigma-Aldrich, Inc. |
| Pt catalyst-1 | trimethyl(methylcyclopentadienyl)platinum(IV), |
| | obtained from Sigma-Aldrich, Inc. |
| Karstedt's | platinum(0)-1,3-divinyl-1,1,3,3-tetramethyldisiloxane |
| catalyst | complex solution in xylene (2.0 wt. %), obtained |
| | from Sigma-Aldrich, Inc. |
| TES | triethoxysilane, purchased from Sigma-Aldrich, Inc. |
| TMS | trimethoxysilane, obtained from Sigma-Aldrich, Inc. |
| VQM-146 | VQM-146, vinyl Q resin dispersion, obtained from |
| | Gelest Inc. |
| HQM-105 | HQM-105 hydride Q-resin, obtained from Gelest Inc. |
| PI film | polyimide film (thickness: 0.025 mm), obtained from |
| | Sigma-Aldrich, Inc. |
| TPU film | thermoplastic polyurethane film |

### Preparation of cyclic poly(ethoxymethyl-co-methylhydro)siloxane (Polymer 1)

SYL-OFF 7048 (10 g, 166.7 mmol of SiH) was mixed with ethanol (3.8 g, 82.6 mmol) in a 100 mL round-bottom flask followed by the addition of Pd/C (0.008 g) at room temperature under nitrogen. The addition of the Pd/C resulted in rapid evolution of hydrogen gas signifying the substitution of ethoxy groups. After 4-5 hr of stirring at room temperature, completion of reaction was confirmed by Fourier transform infrared (FT-IR) spectroscopy (Si—H at ˜2160 cm⁻¹ reduced) analysis of the reaction mixture. To isolate the product, the Pd/C was filtered off using a 1.0-micron glass filter and any unreacted/residual ethanol was then evaporated using vacuum.

### Preparation of cyclic poly(methoxymethyl)-co-poly(methylhydro)siloxane (Polymer 2)

SYL-OFF 7048 (10 g, 166.7 mmol of SiH) was mixed with methanol (2.5 g, 54.3 mmol) in 100 mL round bottom flask followed by the addition of Pd/C (0.008 g) at room temperature under nitrogen. The addition of the Pd/C resulted in rapid evolution of hydrogen gas signifying the substitution of methoxy groups. After 4-5 hr of stirring at room temperature, completion of reaction was confirmed by FT-IR spectroscopy (Si—H at ˜2160 cm⁻¹ reduced) analysis of the reaction mixture. To isolate the product, the Pd/charcoal was filtered off using a 1.0-micron glass filter and any unreacted/residual methanol was then evaporated using vacuum.

### Preparation of linear poly(ethoxymethyl)-co-poly(dimethyl)-co-poly(methylhydro)siloxane (Polymer 3)

Syl-Off 7678 (10 g, 116.9 mmol of SiH) was mixed with ethanol (1.0 g, 21 mmol) in 100 mL round bottom flask followed by the addition of Pd/C (0.008 g) at room temperature under nitrogen. The addition of Pd/C resulted in rapid evolution of hydrogen gas signifying the substitution of ethoxy groups. After 4-5 hr of stirring at room temperature, the completion of reaction was confirmed by FT-IR spectroscopy (Si—H at ˜2160 cm⁻¹ reduced) analysis of the reaction mixture. To isolate the product, the Pd/C was filtered off using a 1.0-micron glass filter and any unreacted/residual ethanol was then evaporated using vacuum.

### Preparation of linear poly(methoxymethyl)-co-poly(dimethyl)-co-poly(methylhydro)siloxane (Polymer 4)

SYL-OFF 7678 (10 g, 116.9 mmol of SiH) was mixed with methanol (0.8 g, 25 mmol) in 100 mL round bottom flask followed by the addition of Pd/C (0.008 g) at room temperature under nitrogen. The addition of Pd/C resulted in rapid evolution of hydrogen gas signifying the substitution of methoxy groups. After 4-5 hr of stirring at room temperature, the completion of reaction was confirmed by FT-IR spectroscopy (Si—H at ˜2160 cm⁻¹ reduced) analysis of the reaction mixture. To isolate the product, the Pd/C was filtered off using a 1.0-micron glass filter and any unreacted/residual methanol was then evaporated using vacuum.

### Examples EX1-EX18 and Comparative Examples CE1-CE3

Curable compositions were prepared by mixing the materials listed in Table 2, below, in 100 grams of a heptane/ethyl acetate mixture (70:30 ratio by weight).

TABLE 2

| | AMOUNT IN GRAMS | | | | | | | | |
|---|---|---|---|---|---|---|---|---|---|
| | Ti(IV) | Ti(IV) | Polymer | Polymer | Polymer | Polymer | | | |
| EXAMPLE | complex-1 | complex-2 | 1 | 2 | 3 | 4 | TES | TMS | HQM-105 |
| EX1 | 5.0 | 0.0 | 5.0 | 0.0 | 0.0 | 0.0 | 0.0 | 0.0 | 0.0 |
| EX2 | 5.0 | 0.0 | 2.5 | 0.0 | 0.0 | 0.0 | 0.0 | 0.0 | 0.0 |
| EX3 | 5.0 | 0.0 | 0.0 | 5.0 | 0.0 | 0.0 | 0.0 | 0.0 | 0.0 |
| EX4 | 5.0 | 0.0 | 0.0 | 2.5 | 0.0 | 0.0 | 0.0 | 0.0 | 0.0 |
| EX5 | 5.0 | 0.0 | 0.0 | 0.0 | 5.0 | 0.0 | 0.0 | 0.0 | 0.0 |
| EX6 | 5.0 | 0.0 | 0.0 | 0.0 | 2.5 | 0.0 | 0.0 | 0.0 | 0.0 |
| EX7 | 5.0 | 0.0 | 0.0 | 0.0 | 0.0 | 5.0 | 0.0 | 0.0 | 0.0 |
| EX8 | 5.0 | 0.0 | 0.0 | 0.0 | 0.0 | 2.5 | 0.0 | 0.0 | 0.0 |
| EX9 | 5.0 | 0.0 | 0.0 | 0.0 | 0.0 | 0.0 | 5.0 | 0.0 | 0.0 |
| EX10 | 5.0 | 0.0 | 0.0 | 0.0 | 0.0 | 0.0 | 0.0 | 5.0 | 0.0 |
| EX11 | 2.0 | 0.0 | 2.0 | 0.0 | 0.0 | 0.0 | 0.0 | 0.0 | 0.0 |
| EX12 | 2.0 | 0.0 | 0.0 | 2.0 | 0.0 | 0.0 | 0.0 | 0.0 | 0.0 |
| EX13 | 2.0 | 0.0 | 0.0 | 0.0 | 2.0 | 0.0 | 0.0 | 0.0 | 0.0 |
| EX14 | 2.0 | 0.0 | 0.0 | 0.0 | 0.0 | 2.0 | 0.0 | 0.0 | 0.0 |
| EX15 | 2.0 | 0.0 | 0.0 | 0.0 | 0.0 | 0.0 | 2.0 | 0.0 | 0.0 |
| EX16 | 2.0 | 0.0 | 0.0 | 0.0 | 0.0 | 0.0 | 0.0 | 2.0 | 0.0 |
| EX17 | 2.0 | 0.0 | 0.0 | 0.0 | 0.0 | 0.0 | 0.0 | 0.0 | 2.0 |
| EX18 | 0.0 | 5.0 | 0.0 | 0.0 | 0.0 | 0.0 | 0.0 | 0.0 | 5.0 |
| CE1 | 5.0 | 0.0 | 0.0 | 0.0 | 0.0 | 0.0 | 0.0 | 0.0 | 0.0 |
| CE2 | 0.0 | 0.0 | 5.0 | 0.0 | 0.0 | 0.0 | 0.0 | 0.0 | 0.0 |
| CE3 | 0.0 | 0.0 | 5.0 | 0.0 | 0.0 | 0.0 | 5.0 | 0.0 | 0.0 |
| CE4 | 0.0 | 0.0 | 0.0 | 0.0 | 0.0 | 0.0 | 0.0 | 0.0 | 0.0 |

### Coating of Tie-Layer on Substrate

Curable compositions in Table 2 were coated onto PI or TPU film specimens using a No. 3 wire-wound rod from R D Specialties, Webster, New York (nominal wet thickness 0.05 mm), followed by heating in an oven at 80° C. for 15-60 seconds to remove the solvent and cure the curable composition.

### Silicone Encapsulant, Coating, and Cure

Preparation of UV Cured Silicone: DMS-V46 (100 grams) or DMS-S45 (100 grams), SYL-OFF 7678 (1.0 grams) were mixed in a 250.0 g opaque plastic bottle. Thereafter, 50 parts per million (ppm) of Pt catalyst-I mixture was added. Pt catalyst-1 mixture was prepared as 2 wt. % Pt catalyst in toluene. To test the adhesion of silicones elastomers on substrate film, silicone material was coated on a film using a knife coater. For comparing the duration of the cure, all the coated silicone materials were kept at the thickness of 0.025 centimeters. The cure of the films was performed under a benchtop UV cure system fitted with two 15-Watt 350 nm black UV lamps. The lamps were kept at the height of 2.0 inches above the samples during the cure.

Preparation of Thermally Cured Silicone: VQM-146 (100 grams), SYL-OFF 7678 (5.0 grams), and diallyl maleate (50 ppm with respect to VQM) were mixed in a 250.0 g plastic bottle. Thereafter, 50 ppm of Karstedt's catalyst was added. To test the adhesion of silicones elastomers on substrate film. The silicone formulation was coated on a substrate film (e.g., polyimide) using a knife coater. For comparing the duration of the cure, all the coated silicone materials were kept at the thickness of 0.025 centimeters. The cure of the films was performed in a benchtop oven at 120° C./1-2 minutes.

### Measurement of Adhesion Between Cured Silicone Elastomer and Substrate Film

Adhesion between the silicone elastomers/encapsulant was measured by hand peeling the cured silicone elastomer from the substrate film and recording the adhesive or cohesive failure of the silicone elastomer/encapsulant. Adhesive failure is noted by easy and clean peeling of the encapsulant without any leftover residue; cohesive failure is measured by tearing of encapsulant while peeling or by the presence of left over encapsulant reside on the film. The adhesion results are summarized in Tables 3 (adhesion to PI film) and 4 (adhesion to TPU film).

TABLE 3

| | UV-CURED SILICONE | | THERMALLY-CURED SILICONE | |
|---|---|---|---|---|
| EXAM- | Adhesive | Cohesive | Adhesive | Cohesive |
| PLE | failure | failure | failure | failure |
| EX1 | No | Yes | No | Yes |
| EX2 | No | Yes | No | Yes |
| EX3 | No | Yes | No | Yes |
| EX4 | No | Yes | No | Yes |
| EX5 | No | Yes | No | Yes |
| EX6 | No | Yes | No | Yes |
| EX7 | No | Yes | No | Yes |
| EX8 | No | Yes | No | Yes |
| EX9 | No | Yes | No | Yes |
| EX10 | No | Yes | No | Yes |
| EX11 | No | Yes | No | Yes |
| EX12 | No | Yes | No | Yes |
| EX13 | No | Yes | No | Yes |
| EX14 | No | Yes | No | Yes |
| EX15 | No | Yes | No | Yes |
| EX16 | No | Yes | No | Yes |
| EX17 | No | Yes | No | Yes |
| EX18 | No | Yes | No | Yes |
| CE1 | Yes | No | Yes | No |
| CE2 | Yes | No | Yes | No |
| CE3 | Yes | No | Yes | No |
| CE4 | Yes | No | Yes | No |

TABLE 4

| | UV-CURED SILICONE | | THERMALLY-CURED SILICONE | |
|---|---|---|---|---|
| EXAM- | Adhesive | Cohesive | Adhesive | Cohesive |
| PLE | failure | failure | failure | failure |
| EX1 | No | Yes | No | Yes |
| EX2 | No | Yes | No | Yes |
| EX3 | No | Yes | No | Yes |
| EX4 | No | Yes | No | Yes |
| EX5 | No | Yes | No | Yes |
| EX6 | No | Yes | No | Yes |
| EX7 | No | Yes | No | Yes |
| EX8 | No | Yes | No | Yes |
| EX9 | No | Yes | No | Yes |
| EX10 | No | Yes | No | Yes |
| EX11 | No | Yes | No | Yes |
| EX12 | No | Yes | No | Yes |
| EX13 | No | Yes | No | Yes |
| EX14 | No | Yes | No | Yes |
| EX15 | No | Yes | No | Yes |
| EX16 | No | Yes | No | Yes |
| EX17 | No | Yes | No | Yes |
| EX18 | No | Yes | No | Yes |
| CE1 | Yes | No | Yes | No |
| CE2 | Yes | No | Yes | No |
| CE3 | Yes | No | Yes | No |
| CE4 | Yes | No | Yes | No |

The preceding description, given in order to enable one of ordinary skill in the art to practice the claimed disclosure, is not to be construed as limiting the scope of the disclosure, which is defined by the claims and all equivalents thereto.

1-16. (canceled)

17. A composite article comprising:
a substrate having a major surface,
a tie layer disposed on the major surface of the substrate, and
a silicone elastomer contacting the tie layer;
wherein the tie layer comprises an at least partially cured curable composition, the curable composition comprising:
(i) a siloxane compound comprising:
m divalent units represented by the formula 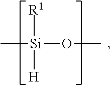
n divalent units represented by the formula 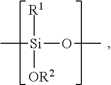
and
p divalent units represented by the formula 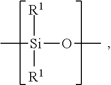
wherein each R¹ independently represents an alkyl group having from 1 to four carbon atoms, each R² independently represents H or an alkyl group having from 1 to four carbon atoms, m and n are integers greater than or equal to 1, and p is an integer greater than or equal to 0; and
(ii) a tetraalkyl orthotitanate.

18. The composite article of claim 17, wherein the siloxane compound has a molecular weight of 400 to 10000 grams/mole.

19. The composite article of claim 17, wherein the tetraalkyl orthotitanate comprises tetrakis(2-ethylhexyl) titanate.

20. The composite article of claim 17, wherein the curable composition is essentially free of water.

21. The composite article of claim 17, wherein p is 0.

22. The composite article of claim 21, wherein the siloxane compound is cyclic.

23. The composite article of claim 17, wherein the ratio m:n:p is 1-5:1-20:0-50.

24. The composite article of claim 23, wherein the ratio m:n is in the range of 1:20 to 20:1, inclusive.

25. The composite article of claim 17, further comprising at least one trialkoxysilane.

26. The composite article of claim 17, wherein the substrate comprises a polymer film.

27. The composite article of claim 26, wherein the polymer film comprises at least one of polyimide or polyurethane.

28. A method of making a composite article, the method comprising:
providing a substrate having a tie layer disposed on a surface thereof;
disposing a curable silicon-containing resin on the tie layer; and
at least partially curing the curable silicon-containing resin,
wherein the tie layer comprises an at least partially cured curable composition, the curable composition comprising
(i) a siloxane compound comprising:
m divalent units represented by the formula 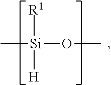
n divalent units represented by the formula 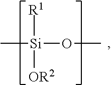
and
p divalent units represented by the formula 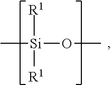
wherein each R¹ independently represents an alkyl group having from 1 to four carbon atoms, each R² independently represents H or an alkyl group having from 1 to four carbon atoms, m and n are integers greater than or equal to 1, and p is an integer greater than or equal to 0; and
(ii) a tetraalkyl orthotitanate.

29. The method of claim 28, wherein said at least partially curing the curable silicon-containing resin comprises photocuring.
